(19) United States
(12) Patent Application Publication
(10) Pub. No.: US 2009/0242100 A1
(43) Pub. Date: Oct. 1, 2009

(54) METHOD FOR MANUFACTURING HONEYCOMB STRUCTURE

(75) Inventor: Takamitsu SAIJO, Dunavarsany (HU)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/393,200

(22) Filed: Feb. 26, 2009

(30) Foreign Application Priority Data
Mar. 27, 2008 (JP) PCT/JP2008/055937

(51) Int. Cl. C04B 35/64

(52) U.S. Cl. 156/89.22; 264/630; 264/41

(57) ABSTRACT

A method for manufacturing a honeycomb structure includes providing a raw material composition for producing silicon carbide including a silica powder and at least one of a carbon powder and a carbon source polymer. The raw material composition is molded to produce a honeycomb molded body having cell walls extending along a longitudinal direction of the honeycomb molded body to define cells. The honeycomb molded body is degreased to obtain a honeycomb degreased body. The honeycomb degreased body is fired to manufacture a honeycomb structure including at least one porous silicon carbide sintered body.

### CROSS-REFERENCE TO RELATED APPLICATIONS

The present application claims priority under 35 U.S.C. §119to PCT Application No. PCT/JP2008/055937, filed Mar. 27, 2008, the contents of which are incorporated herein by reference in their entirety.

### BACKGROUND OF THE INVENTION

1. Field of the Invention

The present invention relates to a method for manufacturing a honeycomb structure.

2. Discussion of the Background

Recently, particulate matter (hereinafter, simply referred to as “particulate” or “PM”) contained in exhaust gases discharged from internal combustions of vehicles such as buses and trucks, construction machines, and the like have become problems as contaminants harmful to the environment and the human body.

For this reason, various honeycomb filters (honeycomb structures) made of porous ceramics have been proposed as filters that can capture particulates in exhaust gases and purify the exhaust gases.

A honeycomb structure including a porous silicon carbide sintered body is proposed as such a honeycomb structure.

Moreover, as a method for manufacturing a honeycomb structure including porous silicon carbide, JP-B-3213850 discloses a method for manufacturing a porous silicon carbide honeycomb sintered body, including: the first step of adding a crystal growth aid as occasion demands to obtain a mixture, by using silicon carbide powder as the starting raw material; the second step of adding a binder for molding to the mixture, molding the mixture in a honeycomb shape, thereafter drying it into a dried product, and cutting and processing the dried product at a cutting velocity high enough to avoid a temperature rise equal to or higher than a predetermined temperature; and the third step of degreasing the dried product if necessary after the processing treatment, then decarbonizing it in an oxidizing atmosphere, and continuously sintering the resultant product at a temperature of 2000 to 2400° C. in an inert gas atmosphere.

The contents of JP-B-3213850 are incorporated herein by reference in their entirety.

### SUMMARY OF THE INVENTION

According to an aspect of the present invention, a method for manufacturing a honeycomb structure includes providing a raw material composition for producing silicon carbide including a silica powder and at least one of a carbon powder and a carbon source polymer. The raw material composition is molded to produce a honeycomb molded body having cell walls extending along a longitudinal direction of the honeycomb molded body to define cells. The honeycomb molded body is degreased to obtain a honeycomb degreased body. The honeycomb degreased body is fired to manufacture a honeycomb structure including at least one porous silicon carbide sintered body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view schematically illustrating one example of a honeycomb structure according to one embodiment of the present invention.

FIG. 2A is a perspective view schematically illustrating one example of a porous silicon carbide sintered body that configures the honeycomb structure shown in FIG. 1, and FIG. 2B is a B-B line cross-sectional view of FIG. 2A.

### DESCRIPTION OF THE EMBODIMENTS

Embodiments will now be described with reference to the accompanying drawings, wherein like reference numerals designate corresponding or identical elements throughout the various drawings.

A method for manufacturing a honeycomb structure according to embodiments of the present invention includes: molding a raw material composition for producing silicon carbide to manufacture a honeycomb molded body in which a large number of cells are longitudinally disposed in parallel with one another with a cell wall therebetween; thereafter, carrying out a degreasing treatment on the honeycomb molded body to manufacture a honeycomb degreased body; and furthermore, carrying out a firing treatment on the honeycomb degreased body to manufacture a honeycomb structure including a porous silicon carbide sintered body; wherein the raw material composition includes at least: a silica powder; and at least one of a carbon powder and a carbon source polymer.

In the firing treatment, the reaction of silica (SiO₂) and carbon (C) shown in the following reaction equation (1) proceeds to the right to thereby generate silicon carbide, and some carbon disappears as gas to thereby generate a porous silicon carbide sintered body.

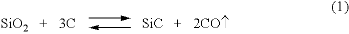

Since the reaction shown in the reaction equation (1) proceeds to the right at a temperature of about 1700° C. or higher, it may become easier to lower a firing temperature and power consumption of a firing furnace in comparison with a conventional method for manufacturing a honeycomb structure by using silicon carbide powder as the starting raw material.

Since silica is consumed in firing to once generate an SiO gas, the portions where SiO₂ has existed tend to be formed as cavities; thus, it may become easier to manufacture a porous silicon carbide sintered body having open pores.

In the method for manufacturing a honeycomb structure according to the embodiments of the present invention, a weight ratio of carbon to silica contained in the honeycomb degreased body is desirably at least about 0.4 and at most about 1.5.

When the weight ratio of silica and carbon contained in the honeycomb degreased body is within the above-mentioned range, the reaction of silica and carbon is more likely to proceed surely in a firing treatment.

In the method for manufacturing a honeycomb structure according to the embodiments of the present invention, the raw material composition may include a binder.

When the raw material composition includes a binder, it is easier to manufacture a honeycomb molded body having the desired shape upon molding a raw material composition to manufacture a honeycomb molded body.

In the method for manufacturing a honeycomb structure according to the embodiments of the present invention, the raw material composition may include a pore-forming agent.

By using a raw material composition in which a pore-forming agent is contained, the desired pores tend to be formed in the manufactured honeycomb structure.

In the method for manufacturing a honeycomb structure according to the embodiments of the present invention, the silica powder desirably has an average particle diameter of at least about 10 μm and at most about 500 μm.

When the silica powder has an average particle diameter of at least about 10 μm and at most about 500 μm, since a raw material composition having a relatively high density tends to be manufactured, a porous silicon carbide sintered body to be obtained tends not to exhibit a low density; thus, it may become easier to obtain a honeycomb structure having the desired porosity and pore diameter and securing sufficient strength.

In the method for manufacturing a honeycomb structure according to the embodiments of the present invention, a silica fine powder and a silica coarse powder that have different average particle diameters may be contained as the silica powder in the raw material composition.

In the method for manufacturing a honeycomb structure according to the embodiments of the present invention, the silica fine powder desirably has an average particle diameter of at least about 0.1 μm and at most about 5 μm, and the silica coarse powder desirably has an average particle diameter of at least about 10 μm and at most about 500 μm.

Since the silica fine powder and the silica coarse powder that have different average particle diameters are contained as the silica powder in the method for manufacturing a honeycomb structure according to the embodiments of the present invention, the blended state of carbon powder and silica powder is favorable, and the manufactured honeycomb structure tends to have the desired porosity and pore diameter and tends to secure sufficient strength.

In the method for manufacturing a honeycomb structure according to the embodiments of the present invention, the raw material composition includes at least a carbon powder, and the carbon powder desirably has an average particle diameter of at least about 1 μm and at most about 40 μm.

In the method for manufacturing a honeycomb structure according to the embodiments of the present invention, since the carbon powder has an average particle diameter of at least about 1 μm and at most about 40 μm, it may become easier to prepare a relatively dense raw material composition. The resulting increase in contact area between silica (SiO₂) and carbon (C) tends to cause the reaction therebetween to proceed more certainly, and the manufactured honeycomb structure tends to have a suitable pore diameter and a high strength.

In the method for manufacturing a honeycomb structure according to the embodiments of the present invention, the firing treatment is desirably carried out at a temperature of at least about 1700° C. and at most about 2000° C.

Even when a firing treatment is conducted at a temperature of at least about 1700° C. and at most about 2000° C. in the method for manufacturing a honeycomb structure according to the embodiments of the present invention, the reaction of silica (SiO₂) and carbon (C) tends to proceed surely, the power consumption in a firing furnace tends to be lowered, not to mention the fact that the sintered body of silicon carbide is manufactured.

In the method for manufacturing a honeycomb structure according to the embodiments of the present invention, the raw material composition may include at least a carbon source polymer, and the carbon source polymer desirably includes at least one of a phenol resin, an ethylene-vinyl acetate copolymer resin, a styrene-butadiene copolymer resin, an acrylonitrile resin, a styrene resin, a polyethylene, a furan resin, a polyimide resin, and a vinyl chloride resin.

By using these resins as a carbon source polymer, carbon tends to remain in a raw material composition even after a degreasing process, and carbon tends to be certainly supplied into the honeycomb degreased body.

In the method for manufacturing a honeycomb structure according to the embodiments of the present invention, the porous silicon carbide sintered body desirably has an average pore diameter of at least about 5 μm and at most about 20 μm and desirably has a porosity of at least about 30% and at most about 60%.

The honeycomb structure including a porous silicon carbide sintered body having such an average pore diameter and porosity tends to be favorably used as a honeycomb filter or a catalyst supporting carrier.

In the method for manufacturing a honeycomb structure according to the embodiments of the present invention, the honeycomb structure maybe formed by one porous silicon carbide sintered body, or the honeycomb structure is formed by combining a plurality of the porous silicon carbide sintered bodies with one another by interposing an adhesive layer.

A method for manufacturing a honeycomb structure according to embodiments of the present invention includes: molding a raw material composition to manufacture a pillar-shaped honeycomb molded body in which a large number of cells are longitudinally disposed in parallel with one another with a cell wall therebetween; thereafter, carrying out a degreasing treatment on the honeycomb molded body to manufacture a honeycomb degreased body; and furthermore, carrying out a firing treatment on the honeycomb degreased body to manufacture a honeycomb structure including a porous silicon carbide sintered body; wherein the raw material composition for producing silicon carbide includes at least: a silica powder; and at least one of a carbon powder and a carbon source polymer.

In the conventional method for manufacturing a honeycomb structure including a porous silicon carbide sintered body by using silicon carbide powder as the starting rawmaterial, as disclosed in JP-B-3213850, it is presumed that the step of carrying out a firing treatment at a high temperature of 2000 to 2400° C. tends to be required.

Therefore, the conventional manufacturing method disclosed in JP-B-3213850 disadvantageously needs a high-temperature firing furnace and also consumes significant amounts of electric power.

Then, wholehearted investigation by the present investors has led to completion of a new method for manufacturing a honeycomb structure based on technical ideas completely different from those of the conventional method for manufacturing a honeycomb structure disclosed in JP-B-3213850.

### First Embodiment

In a method for manufacturing a honeycomb structure according to the first embodiment, a raw material composition for producing silicon carbide is first molded to manufacture a pillar-shaped honeycomb molded body in which a large number of cells are longitudinally disposed in parallel with one another with a cell wall therebetween. The raw material composition includes at least: a silica powder; and at least one of a carbon powder and a carbon source polymer.

The silica powder is not particularly limited, and examples thereof include silica sand, silica gel, colloidal silica, white carbon, finely divided anhydrous silica, and the like.

The silica powder desirably has an overall average particle diameter of at least about 10 μm and at most about 500 μm. When the silica powder having the above-mentioned particle diameter is used, since a raw material composition having a relatively high density tends to be manufactured, the porous silicon carbide sintered body to be obtained tends not to exhibit a low density; thus, it may become easier to obtain a honeycomb structure having the desired porosity and pore diameter and securing sufficient strength.

When carbon powder reacts with silica powder, it is presumed that the reaction of the following equation (2) initially proceeds to the right, SiO having a relatively low boiling point and existing as gas at a reaction temperature is generated, and gasified SiO and carbon (C) become SiC as the reaction of the following equation (3) proceeds to the right.

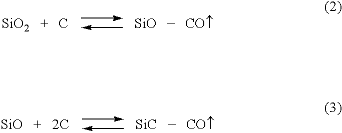

Therefore, when carbon reacts with SiO, carbon may be grown as particles, thereby leading to a possible change in a pore diameter. The portions where silica powder has existed in the raw material composition tend to be formed as pores; conversely, it may become easier to control the pore diameter by controlling the particle diameter of the silica powder.

In the method for manufacturing a honeycomb structure according to the first embodiment, it may become easier to manufacture a porous silicon carbide sintered body having an average pore diameter of at least about 5 μm and at most about 20 μm by using silica powder having an overall average particle diameter of at least about 10 μm and at most about 500 μm.

The carbon powder is not particularly limited, and examples thereof include activated carbon, acetylene black, carbon black, and the like.

The carbon source polymer is not particularly limited, and desirably at least one of a phenol resin, an ethylene-vinyl acetate copolymer resin, a styrene-butadiene copolymer resin, an acrylonitrile resin, a styrene resin, a polyethylene, a furan resin, a polyimide resin, and a vinyl chloride resin. The phenol resin may be a novolac-type or resol-type phenol resin.

The weight ratio of carbon to silica contained in a honeycomb degreased body is desirably at least about 0.4 and at most about 1.5.

When the weight ratio of carbon to silica is about 0.4 or more, a sufficient quantity of carbon quantity is less likely to cause the unreacted silica to remain in the fired body and tends not to result in a reduction in the strength of the fired body. On the other hand, when the weight ratio of carbon to silica of 1.5 or less, an amount of carbon is not excessive, which is less likely to cause carbon to remain in the fired body and tends not to result in a reduction in the strength of the fired body.

The carbon contained in the honeycomb degreased body was used because heating is carried out in an oxygen-containing atmosphere in the degreasing process of the honeycomb molded body, some carbon powder is thereby dissolved and removed, and the amount of the carbon that is actually involved in the reaction is therefore set to the standard values. Accordingly, in order to contain carbon powder, it is necessary to determine the content of the carbon by estimating the dissolution and removal of some carbon powder.

Upon using the carbon powder, about 90% of the carbon powder is presumed to remain even after degreasing. Basically, it may become easier to adjust the residual amount of carbon by adjusting the oxygen concentration in the degreasing process.

When added to the raw material composition, the carbon source polymer is not carbon at first, but carbonized into carbon powder in the degreasing process. Therefore, heating is preliminarily performed on the same conditions as in degreasing, which is followed by, for example, making sure what % by weight of a predetermined amount of phenol resin becomes carbon powder; thereafter, a certain amount of phenol resin is added, so that the target amount of carbon remains after degreasing. In the case of phenol resin, at least about 30% by weight and at most about 60% by weight of the original weight is expected to become carbon after degreasing.

In the embodiments according to the present invention, the raw material composition includes at least: a silica powder; and at least one of a carbon powder and a carbon source polymer, as described above. At least one of the carbon powder and the carbon source polymer are/is added by calculating: the silica powder; and at least one of a carbon powder and a carbon source polymer to have a predetermined ratio after degreasing.

The average particle diameter of the carbon powder contained in the raw material composition is desirably at least about 1 μm and at most about 40 μm, and more desirably at least about 1 μm and at most about 10 μm.

When the carbon powder has an average particle diameter of about 1 μm or more, a pore diameter thereof tends to be large enough; and when the average particle diameter is about 40 μm or less, silica particles are more likely to contact carbon powder, then the reaction between the two tends to proceed, and sufficient strength tends to be secured in the manufactured honeycomb structure.

In the method for manufacturing a honeycomb structure according to the first embodiment, it is desirable to add a binder in a raw material composition for producing silicon carbide.

The binder in the raw material composition is not particularly limited, and examples thereof include methyl cellulose, carboxymethyl cellulose, hydroxyethyl cellulose, polyethylene glycol, and the like.

The blending amount of the binder is desirably at least about 1 part by weight and at most about 10 parts by weight with respect to 100 parts by weight of the raw material composition.

The dispersion medium as water may be added to the raw material composition, if needed. The dispersion medium is not particular limited, and examples thereof include alcohol such as methanol, an organic solvent such as benzene, water, and the like.

The dispersion medium is blended in an appropriate amount so that the viscosity of the mixed composition is set in a certain range.

Furthermore, a pore-forming agent such as balloons that are fine hollow spheres including oxide-based ceramics, spherical acrylic particles, and graphite may be added to the raw material composition, if necessary.

The balloon is not particularly limited, and examples thereof include alumina balloon, glass micro balloon, shirasu balloon, fly ash balloon (FA balloon), mullite balloon, and the like. Alumina balloon is desirable among these.

Furthermore, a molding aid may be added to the raw material composition.

The molding aid is not particularly limited, and examples thereof include ethylene glycol, dextrin, fatty acid soap, fatty acid, polyalcohol, and the like.

A content of the silica powder in the raw material composition is desirably at least about 25% by weight and at most about 70% by weight. In the case where only a carbon powder, not a carbon source polymer, is contained in a raw material composition, the content thereof is desirably at least about 20% by weight and at most about 60% by weight. In the case where a carbon powder and a carbon source polymer are contained together therein, it is necessary to add the two by converting the weight of the carbon powder to be substituted into the weight of the carbon source polymer.

Subsequently, the raw material composition having the above-mentioned composition is mixed by an attritor or the like, sufficiently kneaded by a kneader or the like, extrusion-molded by using a die or the like, cut into a predetermined length, and then dried, to manufacture a pillar-shaped honeycomb molded body in which a large number of cells are longitudinally disposed in parallel with one another with a cell wall therebetween.

The above-mentioned mixing, kneading, extrusion molding, cutting, drying, and the like can be carried out upon manufacturing a porous silicon carbide sintered body by employing conventional methods.

Predetermined cells of the dried honeycomb molded body are filled with the plug material paste, and then undergo drying. Here, the plug material paste may have the same composition as or a different composition from the raw material composition. In addition, sealing may be performed after manufacturing a honeycomb structure.

Subsequently, the honeycomb molded body whose cells have been sealed undergoes a degreasing treatment to manufacture a honeycomb degreased body.

The degreasing is typically carried out by placing the honeycomb molded body on a degreasing jig, thereafter transporting it into a degreasing furnace, and heating it at a temperature of at least about 300° C. and at most about 650° C. in an oxygen-containing atmosphere. This leads to sublimation, dissolution and removal of most of the above binder and the like. The added carbon powder decreases in a predetermined amount, and a carbon source polymer converts to carbon at a predetermined rate.

Subsequently, the honeycomb degreased body is placed on a firing jig, heated and thereby fired at a temperature of at least about 1700° C. and at most about 2000° C. in the atmosphere of inert gas such as nitrogen or argon to generate silicon carbide powder by the reaction and simultaneously sinter the silicon carbide powder adequately, and thereby manufacturing a porous silicon carbide sintered body.

In the embodiment according to the present invention, since a porous silicon carbide sintered body is manufactured by firing a raw material composition which includes: a silica powder; and at least one of a carbon powder and a carbon source polymer and reacting silica with carbon, it may become easier to decrease a firing temperature in comparison with the case of using a silicon carbide powder as a raw material.

It is to be noted that the sequent processes from the degreasing process to the firing process is preferably performed while the honeycomb molded body is placed on a firing jig and remains placed thereon during the degreasing process and the firing process. This tends to allow the degreasing process and the firing process to be effectively conducted, and makes it easier to prevent the honeycomb dried body from being damaged when being placed on a different jig after the degreasing process or in some other occasions.

As thus described, a porous silicon carbide sintered body is more likely to be obtained by: molding a raw material composition for producing silicon carbide to manufacture a pillar-shaped honeycomb molded body in which a large number of cells are longitudinally disposed in parallel with one another with a cell wall therebetween; thereafter, carrying out a degreasing treatment on the honeycomb molded body to manufacture a honeycomb degreased body; and furthermore, carrying out a firing treatment on the honeycomb degreased body.

Desirably, the obtained porous silicon carbide sintered body has an average pore diameter of at least about 5 μm and at most about 20 μm and has a porosity of at least about 30% and at most about 60%.

It is because the honeycomb structure including a porous silicon carbide sintered body having such an average pore diameter and porosity can be appropriately employed as a honeycomb filter or a catalyst supporting carrier.

Here, the porosity and pore diameter can be measured through conventionally known methods, such as a measuring method using a mercury porosimeter, Archimedes method, and a measuring method using a scanning electron microscope (SEM).

Next, an adhesive paste to form the adhesive layer is applied to each of the side faces of the manufactured porous silicon carbide sintered body with an even thickness to form an adhesive paste layer, and a process for successively laminating another porous silicon carbide sintered body on this adhesive paste layer is repeated to manufacture an aggregate of porous silicon carbide sintered bodies having a predetermined size.

Examples of the adhesive paste include a material including: an inorganic binder; an organic binder; and at least one of inorganic fibers and inorganic particles.

Examples of the inorganic binder include silica sol, alumina sol, and the like. These may be used independently or two or more kinds thereof may be used in combination. Silica sol is desirable among the inorganic binders.

Examples of the organic binder include polyvinyl alcohol, methyl cellulose, ethyl cellulose, carboxymethyl cellulose, and the like. These may be used independently or two or more kinds thereof may be used in combination. Carboxymethyl cellulose is desirable among the organic binders.

Examples of the inorganic fibers include: ceramic fibers including silica-alumina, mullite, alumina, and silica; and the like. These may be used independently or two or more kinds thereof may be used in combination. Alumina fibers are desirable among the inorganic fibers.

Examples of the inorganic particles include carbides, nitrides, and the like, and specific examples thereof include: inorganic powder including silicon carbide, silicon nitride and boron nitride; and the like. These may be used independently or two or more kinds thereof may be used in combination. Of the inorganic particles, silicon carbide made of the same material as that of a porous silicon carbide sintered body is desirably used due to its superior thermal conductivity.

Furthermore, a pore-forming agent such as balloons that are fine hollow spheres including oxide-based ceramics, spherical acrylic particles, and graphite may be added to the adhesive paste, if necessary.

The balloon is not particularly limited, and examples thereof include alumina balloon, glass micro balloon, shirasu balloon, fly ash balloon (FA balloon), mullite balloon, and the like. Alumina balloon is desirable among these.

Next, the aggregate of porous silicon carbide sintered bodies is heated so that the adhesive paste layer is dried and solidified to form the adhesive layer.

Moreover, the aggregate of porous silicon carbide sintered bodies in which a plurality of the porous silicon carbide sintered bodies are bonded to one another with an adhesive layer therebetween undergoes a cutting process by using a diamond cutter or the like to manufacture a ceramic block having a round pillar shape.

By forming a sealing material layer around the periphery of the ceramic block by using a sealing material paste, there can be manufactured a honeycomb structure, in which the sealing material layer is formed around the peripheral portion of the round pillar-shaped ceramic block formed by bonding a plurality of the porous silicon carbide sintered bodies to one another by interposing an adhesive layer.

Here, the honeycomb structure may be formed by one porous silicon carbide sintered body instead of bonding a plurality of the porous silicon carbide sintered bodies to one another.

Thereafter, a catalyst is supported on the honeycomb structure on demand. The above-mentioned supporting process of the catalyst may be carried out on the silicon carbide sintered bodies prior to being formed into an aggregate.

In the case where a catalyst is supported thereon, an alumina film (layer) having a high specific surface area is desirably formed on the surface of the honeycomb structure, and a co-catalyst and a catalyst such as platinum are applied to the surface of the alumina film.

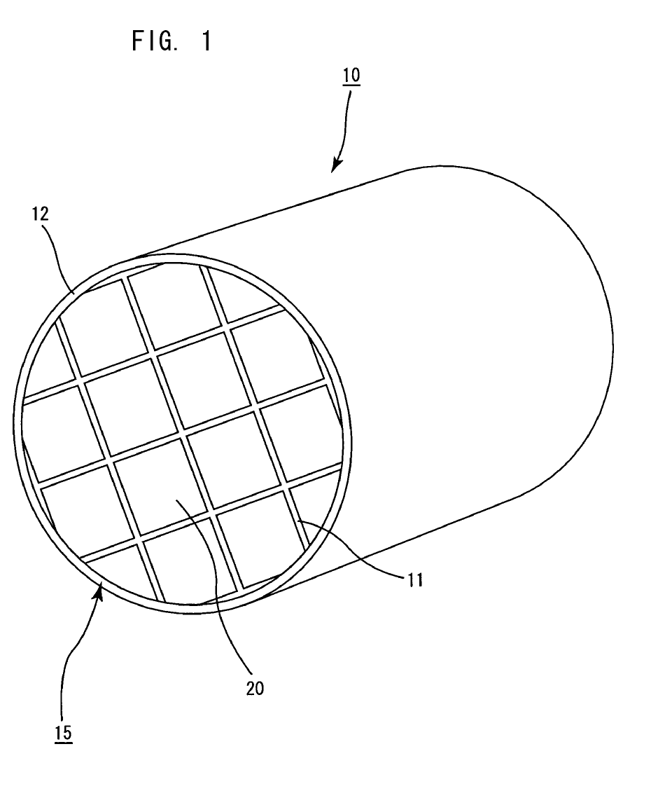

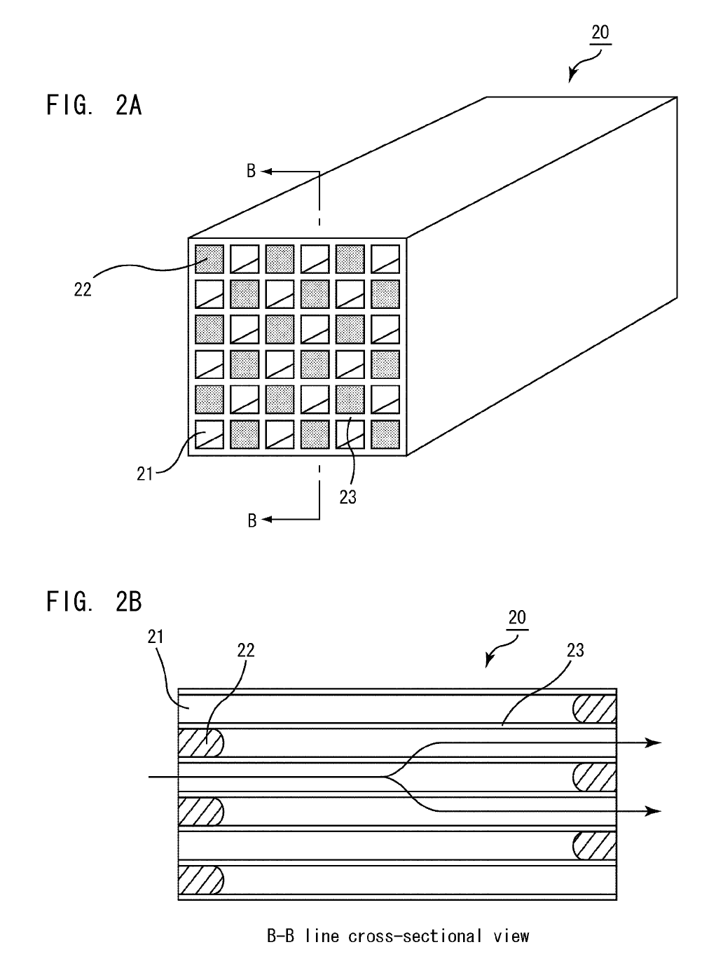

FIG. 1 is a perspective view schematically illustrating one example of a honeycomb structure according to one embodiment of the present invention having the above-mentioned structure. FIG. 2A is a perspective view schematically illustrating one example of a porous silicon carbide sintered body that configures the honeycomb structure shown in FIG. 1, and FIG. 2B is a B-B line cross-sectional view of FIG. 2A.

As illustrated in FIG. 1, a plurality of porous silicon carbide sintered bodies 20 are combined with one another by interposing adhesive layers 11, so that a honeycomb structure 10 configures a ceramic block 15; and a sealing material layer 12 is formed around the periphery of this ceramic block 15.

As illustrated in FIGS. 2A and 2B, the porous silicon carbide sintered body 20 has a structure in which a plurality of cells 21 are longitudinally disposed in parallel with one another and cell walls 23 that separates the cells 21 are allowed to function as filters. In other words, each of the cells 21 formed in the porous silicon carbide sintered body 20 has either one of the end portions on the inlet side or the outlet side of exhaust gases sealed with a plug 22 as illustrated in FIG. 2B so that exhaust gases that have flowed into one of the cells 21 are always allowed to flow out of another cell 21 after having passed through the cell wall 23 that separates the cells 21.

The shape of the honeycomb structure to be manufactured in the embodiment according to the present invention is not limited to a round pillar shape, and, for example, it may be a cylindroid shape, a polygonal shape, or any other desired shape.

A cell wall thickness of the honeycomb structure is not particularly limited, and desirably at least about 0.2 mm and at most about 0.4 mm.

When the cell wall thickness is about 0.2 mm or more, the cell wall which supports the honeycomb structure is so thick that it make it easier to hold the strength of the honeycomb structure; whereas the thickness of about 0.4 mm or less tends not to cause an increase in pressure loss.

The thickness of the outer wall (peripheral wall) that each of the honeycomb fired bodies configuring the honeycomb structure has is not particularly limited, and is desirably at least about 0.2 mm and at most about 0.4 mm, the same thickness as that of a cell wall.

The cell density on a cross section perpendicular to the longitudinal direction of the honeycomb structure is not particularly limited. However, a desirable lower limit is about 31.0 pcs/cm² (about 200 pcs/inch²) and a desirable upper limit is about 93.0 pcs/cm2 (about 600 pcs/inch2 ). A more desirable lower limit is about 38.8 pcs/cm² (about 250 pcs/inch²) and a more desirable upper limit is about 77.5 pcs/cm² (about 500 pcs/inch²).

Hereinafter, the effects of the method for manufacturing a honeycomb structure according to the present embodiment will be described.

(1) Since a silica powder; and at least one of a carbon powder and a carbon source polymer are used as raw materials (raw material compositions for manufacturing silicon carbide) in the method for manufacturing a honeycomb structure according to the present embodiment, it may become easier to manufacture a porous silicon carbide sintered body having a suitable porosity and an suitable average pore diameter even when a firing treatment is performed at a relatively low temperature of at least about 1700° C. and at most about 2000° C.

(2) In the method for manufacturing a honeycomb structure according to the present embodiment, since the weight ratio of carbon to silica contained in the honeycomb degreased body is set in the range of at least about 0.4 and at most about 1.5, the reaction between silica and carbon tends to surely proceed in a firing treatment.

(3) In the method for manufacturing a honeycomb structure according to the present embodiment, since the silica powder has the average particle diameter of at least about 10 μm and at most about 500 μm, a raw material composition having a relatively high density tends to be manufactured, a porous silicon carbide sintered body to be obtained has a density that is not too low, tends to have the desired porosity and pore diameter, and tends to secure sufficient strength.

(4) In the method for manufacturing a honeycomb structure according to the present embodiment, since the silica powder has an average particle diameter of at least about 1 μm and at most about 40 μm, it may become easier to prepare a relatively dense raw material composition. The resulting increase in contact area between silica (SiO₂) and carbon (C) tends to cause the reaction therebetween to proceed more certainly, and the manufactured honeycomb structure tends to have a suitable pore diameter and a high strength.

(5) In the method for manufacturing a honeycomb structure according to the present embodiment, by using a carbon source polymer, carbon tends to remain in a raw material composition even after a degreasing process, and tends to be certainly supplied into the honeycomb degreased body.

(6) In the method for manufacturing a honeycomb structure according to the present embodiment, since a binder is contained in the raw material composition, it is easier to manufacture a honeycomb molded body of the desired shape upon manufacturing a honeycomb molded body by molding a raw material composition.

### EXAMPLES

The following will further describe the present invention by way of Examples, and the present invention is not limited to these Examples.

### Example 1

(1) First, 100 parts by weight of silica powder having an average particle diameter of 22 μm and 40 parts by weight of carbon powder having an average particle diameter of 3 μm were mixed, and to 160 parts by weight of the resulting mixture were added and kneaded 10 parts by weight of an organic binder (methyl cellulose) and 20 parts by weight of water to prepare a mixed composition (raw material composition).

Next, 10 parts by weight of a plasticizer (UNILUB, made by NOF Corporation) and 5 parts by weight of a lubricant (glycerin) were added to the mixed composition (raw material composition), then further kneaded, and thereafter extrusion-molded to manufacture a honeycomb raw molded body having the same rectangular pillar shape as illustrated in FIGS. 2A and 2B.

(2) The above-mentioned raw molded body was dried using a microwave drying apparatus or the like to manufacture a honeycomb dried body. Thereafter, 700 parts by weight of α-type silicon carbide powder having an average particle diameter of 22 μm and 300 parts by weight of α-type silicon carbide powder having an average particle diameter of 0.5 μm were mixed, and to 1000 parts by weight of the resulting mixture were added and kneaded 57 parts by weight of an organic binder (methyl cellulose) and 177 parts by weight of water to prepare a mixed composition. Next, after adding 33 parts by weight of a plasticizer (UNILUB, made by NOF Corporation) and 15 parts by weight of a lubricant (glycerin) to the mixed composition to form a plug material paste, predetermined cells of the honeycomb dried body were filled with the plug material paste.

(3) Next, after having been again dried by using a drying apparatus, the resulting products were degreased at 400° C., and fired at 1800° C. in a normal-pressure argon atmosphere for 3 hours to manufacture a porous silicon carbide sintered body 20, which has a size of 34.3 mm×34.3 mm×150 mm, the number of cells 21 (cell density) of 28 pcs/cm2, a thickness of substantially all the cell walls 23 of 0.30 mm.

(4) By using a heat-resistant adhesive paste containing 30% by weight of alumina fibers having an average fiber length of 20 μm, 21% by weight of silicon carbide particles having an average particle diameter of 0.6 μm, 15% by weight of silica sol (solids content: 30% by weight), 5.6% by weight of carboxymethyl cellulose, and 28.4% by weight of water, a large number of porous silicon carbide sintered bodies 20 were bonded to one another, and this was subsequently cut by using a diamond cutter to manufacture a round pillar-shaped ceramic block 15.

(5) Next, 23.3% by weight of alumina silicate fibers (fiber length: 0.1 to 100 μm), 30.2% by weight of silicon carbide powder having an average particle diameter of 0.3 μm, 7% by weight of silica sol (solids content: 30% by weight), 0.5% by weight of carboxymethyl cellulose, and 39% by weight of water were mixed and kneaded to prepare a sealing material paste.

Next, a sealing material paste layer having a thickness of 0.2 mm was formed around the peripheral portion of the ceramic block 15 by using the sealing material paste. Further, this sealing material paste layer was dried at 120° C. to manufacture a round pillar-shaped honeycomb structure 10 having a size of 143.8 mm in diameter×150 mm in length.

Table 1 shows the above-mentioned manufacturing conditions.

### Comparative Example 1

(1) First, 70 parts by weight of α-type silicon carbide powder having an average particle diameter of 11 μm and 30 parts by weight of α-type silicon carbide powder having an average particle diameter of 0.5 μm were mixed, and to 100 parts by weight of the resulting mixture were added and kneaded 10 parts by weight of acrylic particles having an average particle diameter of 40 μm, 5.7 parts by weight of an organic binder (methyl cellulose) and 26.6 parts by weight of water to prepare a mixed composition.

Next, after 2 parts by weight of a plasticizer (UNILUB, made by NOF Corporation) and 5 parts by weight of a lubricant (glycerin) were added to the mixed composition, then further kneaded, and thereafter extrusion-molded to manufacture a honeycomb raw molded body having the same rectangular pillar shape as illustrated in FIGS. 2A and 2B. Here, the acrylic particles were added as a pore-forming agent to form pores.

(2) After the above-mentioned raw molded body had been dried using a microwave drying apparatus or the like to form a honeycomb dried body, predetermined cells of the honeycomb dried body were filled with a plug material paste having the same composition as that of the raw molded body.

Next, after having been again dried by using a drying apparatus, the resulting products were degreased at 400° C., and fired at 2250° C. in a normal-pressure argon atmosphere for 3 hours to manufacture a porous silicon carbide sintered body 20, which had a porosity of 60%, a size of 34.3 mm×34.3 mm×150 mm, the number of cells 21 (cell density) of 28 pcs/cm2, a thickness of substantially all the cell walls 23 of 0.30 mm.

(3) By using a heat-resistant adhesive paste containing 30% by weight of alumina fibers having an average fiber length of 20 μm, 21% by weight of silicon carbide particles having an average particle diameter of 0.6 μm, 15% by weight of silica sol (solids content: 30% by weight), 5.6% by weight of carboxymethyl cellulose, and 28.4% by weight of water, a large number of porous silicon carbide sintered bodies 20 were bonded to one another, and this was cut by using a diamond cutter to manufacture a round pillar-shaped ceramic block 15.

(4) Next, 23.3% by weight of alumina silicate fibers (fiber length: 0.1 to 100 μm), 30.2% by weight of silicon carbide powder having an average particle diameter of 0.3 μm, 7% by weight of silica sol (solids content: 30% by weight), 0.5% by weight of carboxymethyl cellulose, and 39% by weight of water were mixed and kneaded to prepare a sealing material paste.

Next, a sealing material paste layer having a thickness of 0.2 mm was formed around the peripheral portion of the ceramic block 15 by using the sealing material paste. Further, this sealing material paste layer was dried at 120° C. to manufacture a round pillar-shaped aggregated honeycomb structure 10 having a size of 143.8 mm in diameter×150 mm in length.

Table 1 shows the above-mentioned manufacturing conditions.

### Examples 2 to 9, Comparative Examples 2 and 3

A honeycomb structure 10 was manufactured in the same manner as in Example 1, except that, in the process of manufacturing a honeycomb raw molded body, a mixed composition (raw material composition) was formed by mixing the respective components as shown in Table 1 and a honeycomb raw molded body was manufactured by extrusion molding. Table 1 shows the manufacturing conditions.

### Examples 10 and 11, Comparative Examples 4 and 5

A porous silicon carbide sintered body 20 and then a honeycomb structure were manufactured in the same manner as in Example 1, except that in (1), phenol resin, instead of carbon powder, was added in parts by weight shown in Table 1 and parts by weight of other components were adjusted so as to be the same values as shown in Table 1. Table 1 shows the manufacturing conditions.

TABLE 1

| | Silica powder | | Carbon powder | | | | | | | | |
|---|---|---|---|---|---|---|---|---|---|---|---|
| | Average | | Average | | Carbon source polymer | | Methyl | | | | Firing |
| | particle | Amount | particle | Amount | | Amount | cellulose | Water | Plasticizer | Lubricant | temperature |
| | diameter | (parts by | diameter | (parts by | | (parts by | (parts by | (parts by | (parts by | (parts by | (° C.) |
| | (μm) | weight) | (μm) | weight) | Kind | weight) | weight) | weight) | weight) | weight) | 3 hours |
| Example 1 | 22 | 100 | 3.0 | 40 | NA | NA | 10 | 20 | 10 | 5 | 1800 |
| Example 2 | 22 | 100 | 3.0 | 90 | NA | NA | 13 | 25 | 12 | 6 | 1800 |
| Example 3 | 22 | 100 | 3.0 | 150 | NA | NA | 15 | 35 | 15 | 8 | 1800 |
| Example 4 | 10 | 100 | 3.0 | 60 | NA | NA | 9 | 18 | 10 | 5 | 1800 |
| Example 5 | 200 | 100 | 3.0 | 60 | NA | NA | 9 | 18 | 10 | 5 | 1800 |
| Example 6 | 500 | 100 | 3.0 | 60 | NA | NA | 9 | 18 | 10 | 5 | 1900 |
| Example 7 | 22 | 100 | 10.0 | 90 | NA | NA | 12 | 23 | 12 | 6 | 1800 |
| Example 8 | 22 | 100 | 40.0 | 90 | NA | NA | 12 | 23 | 12 | 6 | 1800 |
| Example 9 | 22 | 100 | 50.0 | 90 | NA | NA | 15 | 32 | 12 | 6 | 1800 |
| Example 10 | 22 | 100 | NA | NA | Phenol resin | 120 | 10 | 20 | 10 | 5 | 1800 |
| Example 11 | 200 | 100 | 3.0 | 60 | Phenol resin | 60 | 12 | 23 | 10 | 5 | 1800 |
| Comparative | *1 11 | 70 | *2 0.5 | 30 | *3 | 10 | 5.7 | 26.6 | 2 | 5 | 2250 |
| Example 1 | | | | | | | | | | | |
| Comparative | 22 | 100 | 3.0 | 160 | NA | NA | 15 | 35 | 12 | 6 | 1800 |
| Example 2 | | | | | | | | | | | |
| Comparative | 22 | 100 | 3.0 | 30 | NA | NA | 10 | 20 | 10 | 5 | 1800 |
| Example 3 | | | | | | | | | | | |
| Comparative | 7 | 100 | NA | NA | Phenol resin | 120 | 10 | 20 | 10 | 5 | 1800 |
| Example 4 | | | | | | | | | | | |
| Comparative | 700 | 100 | 3.0 | 60 | Phenol resin | 60 | 10 | 20 | 10 | 5 | 1800 |
| Example 5 | | | | | | | | | | | |

NA = Not Available
Note:
In Comparative Example 1, *1 denotes an α-type silicon carbide powder having an average particle diameter of 11 μm, *2 denotes an α-type silicon carbide powder having an average particle diameter of 0.5 μm, and *3 denotes acrylic particles having an average particle diameter of 40 μm.

### (Evaluation)

### (1) Measurements of Average Pore Diameter

Each of the porous silicon carbide sintered bodies according to Examples and Comparative Examples was measured for the pore distribution of fine pores in a range of fine pore diameters of 0.1 to 360 μm by using a porosimeter (AutoPore III 9420, manufactured by Shimadzu Corp.) through a mercury porosimetry. Table 2 shows the results.

### (2) Measurements of Average Porosity

Each of the porous silicon carbide sintered bodies according to Examples and Comparative Examples were measured for an average porosity through Archimedes method. Table 2 shows the results.

### (3) Measurements of Pressure Loss Before and After Capturing Particulates

Each of the honeycomb structures according to Examples and Comparative Examples was placed in an exhaust passage of an engine to provide an exhaust gas purifying apparatus, and the engine was driven at the number of revolutions of 3000 min⁻¹ with a torque of 50 Nm for 100 minutes so that the relationship between the captured amount of particulates and pressure loss was measured. Table 2 shows data between the initial pressure loss and transient pressure loss (pressure loss upon capturing 8 g/L of particulates).

### (4) Measurements of Base Member Strength

By using an Instron 5582, a three-point bending test was carried out under conditions of a span distance of 135 mm and a speed of 1 mm/min, so that the bending strength of each of the porous silicon carbide sintered bodies according to Examples and Comparative Examples was measured. Based upon the results of the measurements, the second moment of area was calculated, and the value was converted to a strength value of a base member without the cell structure and given as the base member strength. Table 2 shows the results.

TABLE 2

| | | | Initial | Transient | Base |
|---|---|---|---|---|---|
| | Average pore | Average | pressure | pressure loss | material |
| | diameter | porosity | loss | (kPa) | strength |
| | (μm) | (%) | (kPa) | soot.8 g/L | (MPa) |
| Example 1 | 12 | 42 | 4.0 | 8.0 | 47 |
| Example 2 | 11 | 41 | 4.9 | 9.1 | 45 |
| Example 3 | 7 | 39 | 5.3 | 10.7 | 35 |
| Example 4 | 10 | 38 | 4.1 | 8.4 | 42 |
| Example 5 | 17 | 45 | 2.5 | 5.1 | 37 |
| Example 6 | 20 | 49 | 2.1 | 4.8 | 25 |
| Example 7 | 8 | 38 | 5.9 | 12.1 | 40 |
| Example 8 | 5 | 39 | 4.6 | 9.7 | 34 |
| Example 9 | 5 | 38 | 5.3 | 11.3 | 22 |
| Example 10 | 11 | 43 | 4.2 | 8.1 | 43 |
| Example 11 | 13 | 44 | 3.7 | 7.5 | 39 |
| Comparative | 6 | 41 | 5.8 | 11.5 | 36 |
| Example 1 | | | | | |
| Comparative | 5 | 32 | 6.3 | 13.1 | 18 |
| Example 2 | | | | | |
| Comparative | 20 | 62 | 2.2 | 4.9 | 15 |
| Example 3 | | | | | |
| Comparative | 5 | 33 | 6.2 | 13.0 | 30 |
| Example 4 | | | | | |
| Comparative | 22 | 52 | 2.0 | 4.7 | 20 |
| Example 5 | | | | | |

It has been considered in Table 2 that: each of the honeycomb structures according to Examples 1 to 11 has substantially the same properties as those of the honeycomb structure according to Comparative Example 1; and even in the case of using silica powder, carbon powder, etc. as raw materials to obtain a silicon carbide sintered body by the reaction thereof, it may become easier to obtain a honeycomb structure having the same properties as those in the case of conventionally used silicon carbide powder.

In the case of too much amount of carbon powder as in Comparative Example 2, the initial pressure loss and transient pressure loss became too high and the base member strength decreased; in contrast, in the case of too little amount of carbon powder as in Comparative Example 3, the base member strength decreased.

In the case where an average particle diameter of silica powder was too small as in Comparative Example 4, the initial pressure loss and transient pressure loss became too high; in contrast, in the case where an average particle diameter of silica powder was too large as in Comparative Example 5, the base member strength decreased.

### Second Embodiment

In the method for manufacturing a honeycomb structure according to the second embodiment, silica fine powder and silica coarse powder that have different average particle diameters were contained instead of using one kind of silica powder as a raw material composition. That is, the silica fine powder desirably has an average particle diameter of at least about 0.1 μm and at most about 5 μm, and the silica coarse powder has an average particle diameter of at least about 10 μm and at most about 500 μm.

It is because the blended state of carbon powder and silica powder is favorable when the silica fine powder and the silica coarse powder are contained as thus described; thus, the manufactured honeycomb structure tends to have the desired porosity and pore diameter, and tends to secure sufficient strength.

The silica powder is not particularly limited, and examples thereof include silica sand, silica gel, colloidal silica, white carbon, finely divided anhydrous silica, and the like.

The mixed weight ratio of silica fine powder having an average particle diameter of at least about 0.1 μm and at most about 5 μm to silica coarse powder having an average particle diameter of at least about 10 μm and at most about 500 μm (silica fine powder/silica coarse powder) is desirably at least about 1/9 and at most about 9/1.

Since the second embodiment is the same as the first embodiment except for the above, other descriptions will be omitted.

### Examples 12 to 17

A porous silicon carbide sintered body 20 and then a honeycomb structure were manufactured in the same manner as in Example 1, except that in (1), silica coarse powder and silica fine powder, instead of 100 parts by weight of silica powder having the average particle diameter of 22 μm, were used in parts by weight shown in Table 3 and parts by weight of other components were adjusted so as to be the same values as shown in Table 3. Table 3 shows the manufacturing conditions.

TABLE 3

| | Silica coarse powder | | Silica fine powder | | Carbon powder | | | | | | |
|---|---|---|---|---|---|---|---|---|---|---|---|
| | Average | | Average | | Average | | Methyl | | | | Firing |
| | particle | Amount | particle | Amount | particle | Amount | cellulose | Water | Plasticizer | Lubricant | temperature |
| | diameter | (parts by | diameter | (parts | diameter | (parts by | (parts by | (parts by | (parts by | (parts by | (° C.) |
| | (μm) | weight) | (μm) | by weight) | (μm) | weight) | weight) | weight) | weight) | weight) | 3 hours |
| Example 12 | 50 | 30 | 3.0 | 70 | 3.0 | 90 | 10 | 20 | 10 | 5 | 1800 |
| Example 13 | 50 | 60 | 3.0 | 40 | 3.0 | 90 | 10 | 20 | 10 | 5 | 1800 |
| Example 14 | 50 | 80 | 3.0 | 20 | 3.0 | 90 | 10 | 20 | 10 | 5 | 1800 |
| Example 15 | 10 | 40 | 3.0 | 60 | 3.0 | 90 | 10 | 20 | 10 | 5 | 1800 |
| Example 16 | 200 | 40 | 3.0 | 60 | 3.0 | 90 | 10 | 20 | 10 | 5 | 1800 |
| Example 17 | 500 | 40 | 3.0 | 60 | 3.0 | 90 | 10 | 20 | 10 | 5 | 1800 |

### (Evaluation)

Measurements were made in the same manner as in Example 1, regarding average pore diameters, porosities, pressure loss before and after capturing particulates, and base member strength. Table 4 shows the results.

TABLE 4

| | Average | | | Transient | Base |
|---|---|---|---|---|---|
| | pore | Average | Initial | pressure loss | material |
| | diameter | porosity | pressure loss | (kPa) | strength |
| | (μm) | (%) | (kPa) | soot.8 g/L | (MPa) |
| Example 12 | 12 | 41 | 4.2 | 8.1 | 48 |
| Example 13 | 12 | 42 | 4.9 | 9.0 | 46 |
| Example 14 | 13 | 43 | 5.0 | 9.1 | 45 |
| Example 15 | 11 | 43 | 4.6 | 8.6 | 47 |
| Example 16 | 16 | 44 | 2.7 | 5.5 | 35 |
| Example 17 | 19 | 47 | 2.3 | 4.9 | 25 |

It has been considered in Table 4 that: each of the honeycomb structures according to Examples has substantially the same properties as those of the honeycomb structure according to Comparative Example 12 to 17; and even in the case of using silica coarse powder and silica fine powder, and carbon powder, etc. as raw materials to obtain a silicon carbide sintered body by the reaction thereof, it may become easier to obtain a honeycomb structure having the same properties as those in the case of conventionally used silicon carbide powder.

When the properties of the honeycomb structures of Examples 12 to 17 in the case of using silica coarse powder and silica fine powder, and carbon powder, etc. as raw materials were compared with the properties of the honeycomb structures of Examples 1 to 11 in the case of using silica powder and carbon powder each having a particle diameter of one kind, it is considered that both properties did not exhibit any specific differences.

Also in the method for manufacturing a honeycomb structure according to the present embodiment, the same effects (1), (2), (4), and (5) as in the honeycomb structure according to the first embodiment can be exerted.[0098]

In the method for manufacturing a honeycomb structure according to the present embodiment, silica fine powder and silica coarse powder were contained, the silica fine powder has an average particle diameter of at least about 0.1 μm and at most about 5 μm, and the silica coarse powder has an average particle diameter of at least about 10 μm and at most about 500 μm; therefore, the blended state of carbon powder and silica powder is favorable, and the manufactured honeycomb structure tends to have the desired porosity and pore diameter, and tends to secure sufficient strength.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method for manufacturing a honeycomb structure, comprising:
providing a raw material composition for producing silicon carbide, said composition comprising a silica powder and at least one of a carbon powder and a carbon source polymer;
molding the raw material composition to produce a honeycomb molded body having cell walls extending along a longitudinal direction of the honeycomb molded body to define cells;
degreasing the honeycomb molded body to obtain a honeycomb degreased body; and
firing the honeycomb degreased body to manufacture a honeycomb structure comprising at least one porous silicon carbide sintered body.

2. The method for manufacturing a honeycomb structure according to claim 1,
wherein
a weight ratio of carbon to silica contained in said honeycomb degreased body is from about 0.4 to about 1.5.

3. The method for manufacturing a honeycomb structure according to claim 1,
wherein
the raw material composition further comprises a binder.

4. The method for manufacturing a honeycomb structure according to claim 1,
wherein
the raw material composition further comprises a pore-forming agent.

5. The method for manufacturing a honeycomb structure according to claim 1,
wherein
said silica powder has an average particle diameter from about 10 μm to about 500 μm.

6. The method for manufacturing a honeycomb structure according to claim 1, wherein the silica powder comprises
a silica fine powder having a first average particle diameter, and
a silica coarse powder having a second average particle diameter different from the first average particle diameter.

7. The method for manufacturing a honeycomb structure according to claim 6,
wherein
said silica fine powder has an average particle diameter from about 0.1 μm to about 5 μm, and
said silica coarse powder has an average particle diameter from about 10 μm to about 500 μm.

8. The method for manufacturing a honeycomb structure according to claim 1, wherein the raw material composition comprises a carbon powder which has an average particle diameter from about 1 μm to about 40 μm.

9. The method for manufacturing a honeycomb structure according to claim 1, wherein the honeycomb degreased body is fired at a temperature from about 1700° C. to about 2000° C.

10. The method for manufacturing a honeycomb structure according to claim 1, wherein the raw material composition comprises a carbon source polymer which comprises at least one of a phenol resin, an ethylene-vinyl acetate copolymer resin, a styrene-butadiene copolymer resin, an acrylonitrile resin, a styrene resin, a polyethylene, a furan resin, a polyimide resin, and a vinyl chloride resin.

11. The method for manufacturing a honeycomb structure according to claim 1,
wherein
said at least one porous silicon carbide sintered body has an average pore diameter from about 5 μm to about 20 μm and has a porosity from about 30% to about 60%.

12. The method for manufacturing a honeycomb structure according to claim 1,
wherein
said honeycomb structure is formed by one porous silicon carbide sintered body of said at least one porous silicon carbide sintered body.

13. The method for manufacturing a honeycomb structure according to claim 1,
wherein
said honeycomb structure is formed by combining a plurality of porous silicon carbide sintered bodies of said at least one porous silicon carbide sintered body with one another by interposing an adhesive layer.

14. The method for manufacturing a honeycomb structure according to claim 1,
wherein
said silica powder comprises at least one of silica sand, silica gel, white carbon, and finely divided anhydrous silica.

15. The method for manufacturing a honeycomb structure according to claim 1,
wherein
said carbon powder comprises at least one of activated carbon, acetylene black, and carbon black.

16. The method for manufacturing a honeycomb structure according to claim 1,
wherein
a content of the silica powder in said raw material composition is from about 25% by weight to about 70% by weight.

17. The method for manufacturing a honeycomb structure according to claim 1,
wherein
said raw material composition contains said carbon powder and does not contain said carbon source polymer, and
a content of said carbon powder in said raw material composition is from about 20% by weight to about 60% by weight.

18. The method for manufacturing a honeycomb structure according to claim 1, further comprising:
filling predetermined cells of said honeycomb molded body with a plug material paste before degreasing the honeycomb molded body and firing the honeycomb degreased body.

19. The method for manufacturing a honeycomb structure according to claim 1, wherein said sealing material paste has a composition same as a compositon of said raw material composition.

20. The method for manufacturing a honeycomb structure according to claim 1,
wherein
said honeycomb molded body is placed on a firing jig and remains placed thereon during degreasing the honeycomb molded body and firing the honeycomb degreased body.

21. The method for manufacturing a honeycomb structure according to claim 3,
wherein
said binder comprises at least one of methyl cellulose, carboxymethyl cellulose, hydroxyethyl cellulose and polyethylene glycol.

22. The method for manufacturing a honeycomb structure according to claim 3,
wherein
a blending amount of said binder is from about 1 part by weight to about 10 parts by weight with respect to 100 parts by weight of said raw material composition.
